(19) United States
(12) Patent Application Publication
(10) Pub. No.: US 2017/0308191 A1
(43) Pub. Date: Oct. 26, 2017

(54) INTERACTIVE SYSTEM AND METHOD THEREOF FOR CONTROLLING MULTIPLE REMOTE DEVICES

(71) Applicant: PIXART IMAGING INC., HSIN-CHU (TW)

(72) Inventors: CHING-LIN CHUNG, Hsin-Chu (TW); CHIA-FU KE, Hsin-Chu (TW); JR-SHEN YANG, Hsin-Chu (TW); YEN-MIN CHANG, Hsin-Chu (TW)

(21) Appl. No.: 15/285,796

(22) Filed: Oct. 5, 2016

(30) Foreign Application Priority Data
Apr. 20, 2016 (TW) 105112262

(51) Int. Cl. G06F 3/0354; G06F 3/16; E05B 35/00; H04W 76/02; G06F 3/0346; H04W 4/00; H04W 84/18

(52) U.S. Cl. CPC G06F 3/03545; G06F 3/0346; G06F 3/16; H04W 4/008; E05B 35/001; H04W 76/02; G06F 2203/0383; H04W 84/18; G06F 2203/0384

(57) ABSTRACT

Provided herein are an interactive system and a method thereof for controlling multiple remote devices. The method is executed by a portable navigation device to establish an interactive system including the portable navigation device, a host device and at least one controlled device. The portable navigation device, the host device and the least one controlled device communicate with one another according to at least one protocol. The host device receives an interactive interface provided by the least one controlled device. A cursor with respect to the host device is controlled by the portable navigation device. The least one controlled device corresponding to the interactive interface is controlled according to a motion of the cursor on the interactive interface to execute a function corresponding to the motion. Accordingly, the present invention achieves controlling the least one controlled device or transmitting data using the portable navigation device and the host device.

### BACKGROUND

### 1. Technical Field

The present invention generally relates to an interactive system and a method thereof and, more particularly, to an interactive system for controlling multiple remote devices and a method thereof using a portable navigation device.

### 2. Description of Related Art

Computer-based facilities are widely used in our daily lives because it is an era of information explosion. Peripherals for operating computers providing higher precision, more comfortability and more functions have drawn much attention. For example, manufacturers have focused on the improvements of peripherals such as keyboards and mice.

Among the peripherals, the portable navigation device such as a pen mouse is an improvement of a pen-shaped mouse that enables the user to hold it like a pen to control a computer. The pen mouse outperforms the conventional mouse in graphics, operations and so forth.

However, the pen mouse only replaces the conventional mouse in controlling the cursor on the computer without including further convenient features. Accordingly, there is a need for much improvement between the computer and peripherals.

### SUMMARY

One embodiment of the present invention provides an interactive system, including a portable navigation device, a host device, and at least one controlled device. The portable navigation device, the host device and the at least one controlled device communicate with one another according to at least one protocol to establish the interactive system. The host device receives an interactive interface provided by the at least one controlled device. The portable navigation device controls a cursor with respect to the host device, executes a program of the host device or the at least one controlled device and controls the output of an application of the host device or the at least one controlled device. The at least one controlled device corresponding to the interactive interface is controlled according to a motion of the cursor on the interactive interface to execute a function corresponding to the motion.

One embodiment of the present invention further provides an interactive method for controlling multiple remote devices. The interactive method is executed by a portable navigation device. The interactive method includes the steps as follows. An interactive system is established by linking the portable navigation device, a host device and at least one controlled device communicating with one another according to at least one protocol. The host device receives an interactive interface provided by the at least one controlled device. The portable navigation device controls a cursor with respect to the host device, executes a program of the host device or the at least one controlled device and controls the output of an application of the host device or the at least one controlled device. The at least one controlled device corresponding to the interactive interface is controlled according to a motion of the cursor on the interactive interface to execute a function corresponding to the motion.

In summary, an interactive system and a method thereof for controlling multiple remote devices according to the present invention use a portable navigation device, a host device and at least one controlled device communicating with one another according to at least one protocol to establish the interactive system including the portable navigation device, the host device and the at least one controlled device such that the user may use the portable navigation device to control the controlled device through the host device or conduct data transmission. Accordingly, operations and data transmission between computers and various electronic devices become more convenient and diverse.

In order to further understand the techniques, means and effects of the present invention, the following detailed descriptions and appended drawings are hereby referred to, such that, and through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain the principles of the present invention.

FIG. 1 is a schematic diagram of an interactive system for controlling multiple remote devices according to one embodiment of the present invention;

FIG. 2 is a schematic diagram of an interactive system for controlling multiple remote devices according to another embodiment of the present invention;

FIG. 3 is a schematic diagram of an interactive system for controlling multiple remote devices according to still another embodiment of the present invention;

FIG. 4A and FIG. 4B are schematic diagrams of an interactive system for controlling multiple remote devices according to another embodiment of the present invention;

FIG. 5 is a flowchart of an interactive method for controlling multiple remote devices according to one embodiment of the present invention;

FIG. 6 is a flowchart of an interactive method for controlling multiple remote devices according to another embodiment of the present invention;

FIG. 7 is a flowchart of an interactive method for controlling multiple remote devices according to still another embodiment of the present invention; and

FIG. 8 is a flowchart of an interactive method for controlling multiple remote devices according to still another embodiment of the present invention.

### DESCRIPTION OF THE EXEMPLARY EMBODIMENTS

The detailed description set forth below in connection with the appended drawings is intended as a description of certain embodiments of the present invention, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present invention.

While such terms as “first,” “second,” etc., may be used to describe various components, such components must not be limited to the above terms. The above terms are used only to distinguish one component from another. For example, a second component may be referred to as a first component within the scope of the present invention, and similarly, the first component may be referred to as the second component. As used herein, the term “and/or” includes any and all combinations of one or more of the associated listed items.

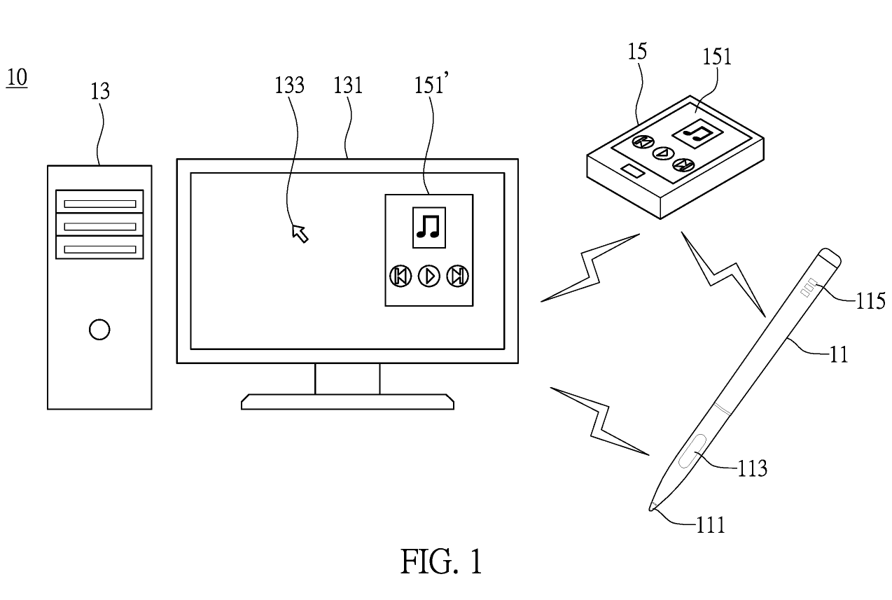

Referring to FIG. 1, FIG. 1 is a schematic diagram of an interactive system for controlling multiple remote devices according to one embodiment of the present invention. In FIG. 1, the interactive system 10 includes a portable navigation device 11, a host device 13 and a controlled device 15. The portable navigation device 11 includes a detection unit 111, a button 113 and a microphone 115. The host device 13 includes a display module 131. In the present invention, the interactive system for controlling multiple remote devices includes at least one controlled device 15, which is exemplified by a controlled device 15 in the present embodiment. The portable navigation device 11 is a pen mouse, to which the present invention is not limited.

The portable navigation device 11, the host device 13 and the controlled device 15 communicate with one another according to at least one protocol to establish the interactive system 10 after receiving an activation signal. Accordingly, the interactive system 10 includes the portable navigation device 11, the host device 13 and the controlled device 15. The activation signal is a trajectory signal corresponding to a movement of the portable navigation device 11 detected by the detection unit 111, an audio signal provided by the user and received by the microphone 115 or an input signal when the button 113 of the portable navigation device 11 is being pressed. However, the present invention is not limited thereto. The communication protocol may be Bluetooth, Wi-Fi, near field communication (NFC), ZigBee or radio frequency identification (RFID), to which the present invention is not limited. The detection unit 111 of the portable navigation device 11 is an optical displacement sensor, to which the present invention is not limited.

The controlled device 15 includes an interactive interface 151 capable of being browsed or operated by the user. After the interactive system 10 is established, the host device 13 receives an interactive interface 151′ corresponding to the interactive interface 151 provided by the controlled device 15, and displays the interactive interface 151′ on the display module 131. The user can operate the portable navigation device 11 to provide a movement thereof. The detection unit 111 of the portable navigation device 11 is capable of detecting the movement of the portable navigation device 11 so as to control a cursor 133 displayed on the display module 131 corresponding to the host device 13. Meanwhile, the user can operate the portable navigation device 11 to control the cursor 133 to conduct a motion of the cursor 133, such as a click or a drag. The host device 13 can control the controlled device 15 according to the motion of the cursor 133 on the interactive interface 151′ so as to execute a function corresponding to the motion.

For example, as shown in FIG. 1, the controlled device 15 is exemplified by a smart phone. The interactive interface 151 is, for example, a music playing program. After the interactive system is established, the host device 13 receives the interactive interface 151′ corresponding to the interactive interface 151 provided by the controlled device 15, and displays the interactive interface 151′ on the display module 131. Meanwhile, the user can operate the portable navigation device 11 to control the cursor 133 to conduct a motion of the cursor 133, such as a click or a drag, on the interactive interface 151′ such that a function corresponding to the motion is executed by the controlled device 15 corresponding to the interactive interface 151′. For example, the user can operate the portable navigation device 11 to select a “PLAY” area on the interactive interface 151′ such that the controlled device 15 executes a music playing function or click a “PREVIOUS/NEXT” area on the interactive interface 151′ such that the controlled device 15 executes a track selection function. Moreover, the user can operate the portable navigation device 11 to select and drag the interactive interface 151′ to change its position on the display module 131. Accordingly, the portable navigation device 11 can be used to control the controlled device 15 through the host device 13.

In one embodiment of the present invention, the portable navigation device 11 is linked to the host device 13 and the controlled device 15, respectively, after the activation signal is received so as to establish the interactive system 10 including the portable navigation device 11, the host device 13 and the controlled device 15. The host device 13 and the controlled device 15 are not directly connected. Instead, when the host device 13 controls the controlled device 15, the host device 13 receives the interactive interface 151′ corresponding to the interactive interface 151 provided by the controlled device 15 through an interconnection between the portable navigation device 11 and the controlled device 15. Meanwhile, the controlled device 15 transmits the data of the interactive interface 151 to the portable navigation device 11, and the portable navigation device 11 transmits the data of the interactive interface 151 to the host device 13. The host device 13 displays the interactive interface 151′ corresponding to the interactive interface 151 on the display module 131. When the portable navigation device 11 is used to control the controlled device 15 or execute data transmission through the host device 13, the host device 13 controls the data or executes data transmission through the interconnection between the portable navigation device 11 and the controlled device 15.

In one embodiment of the present invention, the portable navigation device 11 is linked to the host device 13 and the controlled device 15, respectively, after the activation signal is received. The host device 13 is further linked to the controlled device 15 to establish the interactive system 10 including the portable navigation device 11, the host device 13 and the controlled device 15. When the host device 13 is used to control the controlled device 15, the host device 13 directly receives the interactive interface 151′ corresponding to the interactive interface 151 provided by the controlled device 15 through the interconnection between the host device 13 and the controlled device 15, and directly executes the functions such as controlling the controlled device 15 or data transmission with the controlled device 15.

In one embodiment of the present invention, the user performs voice control through a microphone 115 of the portable navigation device 11. The microphone 115 receives an audio signal provided by the user. The portable navigation device 11 controls the host device 13 according to the audio signal and/or the controlled device 15 executes a voice control function corresponding to the audio signal. For example, when the user says “PLAY”, the portable navigation device 11 controls the controlled device 15 through the host device 13 to play music. When the user says “STOP”, the portable navigation device 11 controls the controlled device 15 through the host device 13 to stop playing music. The user may also control the host device 13 through voice from the microphone 115.

In one embodiment of the present invention, the user uses the microphone 115 of the portable navigation device 11 to record their voice, and store the recorded data in the host device 13 and/or the controlled device 15 so as to complete voice recording by the portable navigation device 11.

In one embodiment of the present invention, the detection unit 111 of the portable navigation device 11 provides a pressure detection function to detect a pressure signal due to a force applied by the user when operating the portable navigation device 11 to control the host device 13. Practically, the pressure signal due to the force applied on the portable navigation device 11 can be used to present the color depth or other functions according to the applied force.

In one embodiment of the present invention, the portable navigation device 11 further comprises a motion sensor (not shown). The motion sensor can be a displacement sensor, a velocity sensor, an acceleration sensor, a force sensor, a strain sensor, a torsional vibration sensor, a torque sensor or a direction sensor, to which the present invention is not limited. The user can operate the portable navigation device 11 to shake or vibrate such that the motion sensor provides a motion signal to control the host device 13 or the controlled device 15 to, for example, execute or control a program.

In one embodiment of the present invention, after the interactive system is established by linking the portable navigation device 11, the host device 13 and the at least one controlled device 15 communicating with one another according to at least one protocol, the host device 13 receives the interactive interface 151′ corresponding to the interactive interface 151 provided by the controlled device 15, and displays the interactive interface 151′ on the display module 131. In the interactive system 10, the portable navigation device 11 can activate a program of the host device 13 or the controlled device 15. For example, the user can use the microphone 115 to activate a program of the host device 13 or the controlled device 15 by voice control. For example, when the user says “BROWSER”, a web browser program of the host device 13 or the controlled device 15 can be activated for web browsing. Moreover, when the user says “PLAYER”, a player program of the host device 13 or the controlled device 15 can be activated for playing music or video. Furthermore, for example, the user can shake or vibrate the portable navigation device 11 to cause a motion sensor (not shown) of the portable navigation device 11 to provide a motion signal to activate a program of the host device 13 or the controlled device 15 corresponding to the motion signal. Moreover, for example, the user can operate the portable navigation device 11 to move to provide a trajectory signal to activate a program of the host device 13 or the controlled device 15 corresponding to the trajectory signal.

In one embodiment of the present invention, after the interactive system is stablished, the host device 13 receives the interactive interface 151′ corresponding to the interactive interface 151 provided by the controlled device 15, and displays the interactive interface 151′ on the display module 131. In the interactive system 10, the portable navigation device 11 can control the output of a program of the host device 13 or the controlled device 15. For example, the user can use the microphone 115 to control the output of a program of the host device 13 or the controlled device 15 by voice control. Taking a music playing program for example, when the user says “VOLUME UP/VOLUME DOWN”, the output volume of a music playing program of the host device 13 or the controlled device 15 can be controlled to achieve volume control. Moreover, the user can say “PREVIOUS/NEXT” to control the output of track selection by a music playing program of the host device 13 or the controlled device 15 to achieve track selection control. Moreover, the user can shake or vibrate the portable navigation device 11 to cause a motion sensor (not shown) of the portable navigation device 11 to provide a motion signal to control the output of a program of the host device 13 or the controlled device 15 corresponding to the motion signal. Taking a web browser program for example, the user can shake the portable navigation device 11 to control the scroll up/down operation of the browser program. Moreover, for example, the user can operate the portable navigation device 11 to move to provide a trajectory signal to control the output of a program of the host device 13 or the controlled device 15 corresponding to the trajectory signal. Taking a web browser program for example, the user can operate the portable navigation device 11 to move up/down to provide a trajectory signal to control the scroll up/down operation of the browser program.

The host device 13 and/or the controlled device 15 may be a desktop computer, a notebook computer, a smart TV, a stereo system, an audio/video player, a smart phone, a tablet computer or a smart wearable device, to which the present invention is not limited. For example, when the host device 13 is a desktop computer and the controlled device 15 is a smart phone, the user uses the portable navigation device 11 to operate the desktop computer to control the smart phone so as to conduct data transmission between the smart phone and the desktop computer or execute the functions on the smart phone.

Alternatively, when the host device 15 is a smart TV and the controlled device 15 is a tablet computer, the user uses the portable navigation device 11 to operate the smart TV to control the tablet computer so as to conduct data transmission between the tablet computer and the smart TV or execute the functions on the tablet computer. Therefore, the interactive system for controlling multiple remote devices according to the present invention uses a portable navigation device to establish the interactive system such that operations and data transmission between computers and various electronic devices become more convenient and diverse.

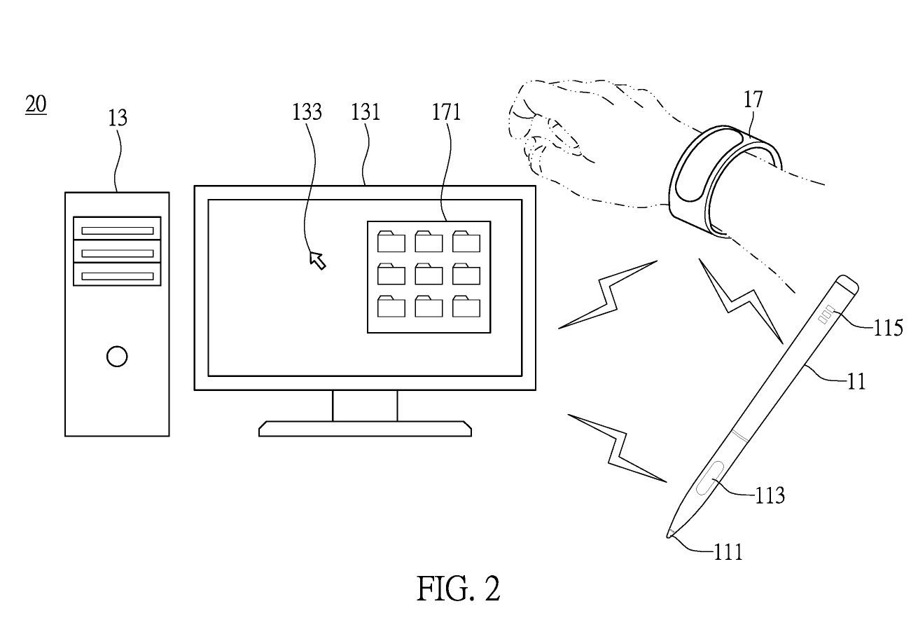

Referring to FIG. 2, FIG. 2 is a schematic diagram of an interactive system for controlling multiple remote devices according to another embodiment of the present invention. In FIG. 2, the interactive system 20 includes a portable navigation device 11, a host device 13 and a controlled device 17. The portable navigation device 11 includes a detection unit 111, a button 113 and a microphone 115. The host device 13 includes a display module 131. In the present embodiment, the interactive system for controlling multiple remote devices includes at least one controlled device 17, which is exemplified by a controlled device 17 in the present embodiment. The portable navigation device 11 is a pen mouse, to which the present invention is not limited.

The present embodiment is different from the embodiment in FIG. 1 in that the controlled device 17 in the present embodiment does not include an interactive interface. For example, the controlled device 17 is a smart bracelet without a display, to which the present invention is not limited. As shown in FIG. 2, the controlled device 17 does not include an interactive interface. After the interactive system is established, the host the host device 13 receives an interactive interface 171 provided by the controlled device 13, and displays the interactive interface 171 on the display module 131. Meanwhile, the user can operate the portable navigation device 11 to control the cursor 133 to conduct a motion of the cursor 133, such as a click or a drag, on the interactive interface 171 such that a function corresponding to the motion is executed by the controlled device 17 corresponding to the interactive interface 171. The host device 13 can control the controlled device 15 according to the motion of the cursor 133 on the interactive interface 151′ so as to execute a function corresponding to the motion. Accordingly, the portable navigation device 11 can be used to control the controlled device 17 through the host device 13.

As shown in FIG. 2, the interactive interface 171 provided by the controlled device 17 is, for example, a file management program capable of displaying icons representing various data files stored in the controlled device 17, the host device 13 or the cloud network (not shown). The user can operate the portable navigation device 11 to control the cursor 133 to conduct a motion of the cursor 133 on the interactive interface 171 such that a function corresponding to the motion is executed by the controlled device 17 corresponding to the interactive interface 171. For example, the user can operate the portable navigation device 11 to select and drag an icon on the interactive interface 171 representing a data file to the display module 131 to copy the data file to the host device 13. Alternatively, the user can select and drag an icon on display module 131 representing a data file in the host device 13 to the interactive interface 171 to copy the data file to the controlled device 17. Accordingly, the portable navigation device 11 can be used to control the controlled device 17 through the host device 13 to perform data transmission.

Data transmission can be conducted between the host device 13 and the controlled device 17 corresponding to the interactive interface 171 through the portable navigation 11. Meanwhile, the host device 13 transmits the data to the portable navigation device 11, and the portable navigation device 11 transmits the data to the controlled device 17. The data is transmitted through the portable navigation device 11 without direct interconnection between the host device 13 and the controlled device 17 such that the interactive system of the present invention provides simple and convenient data transmission.

Alternatively, the data can also be transmitted directly between the host device 13 and the controlled device 17 such that the interactive system of the present invention provides rapid data transmission.

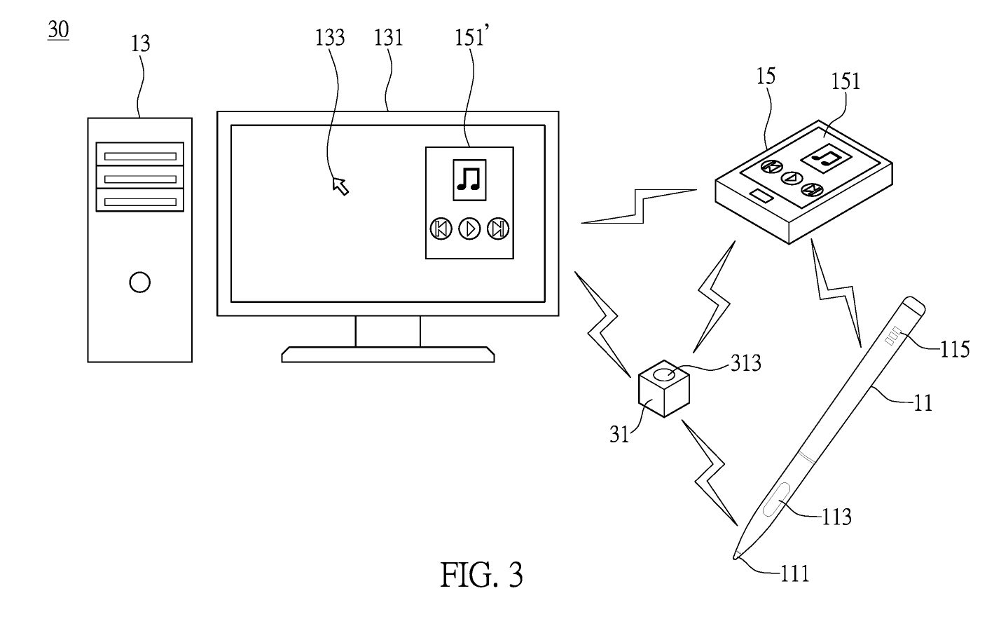

Referring to FIG. 3, FIG. 3 is a schematic diagram of an interactive system for controlling multiple remote devices according to still another embodiment of the present invention. In FIG. 3, the interactive system 30 includes a portable navigation device 11, a host device 13, a controlled device 15 and a central control device 31. The present embodiment is different from the embodiment in FIG. 1 in that the interactive system 30 in the present embodiment further comprises a central control device 31. The central control device 31 includes a socket 313. The socket 313 can receive the portable navigation device 11 when the portable navigation device 11 is not being used. The socket 313 may further provide a charging function to charge the portable navigation device 11.

The central control device 31 can be linked wiredly or wirelessly to the portable navigation device 11, the host device 13 and/or the controlled device 15, respectively. After an activation signal is received, an interactive system 30 is established using the central control device 31 to include the host device 13 and the controlled device 15. The user can operate the portable navigation device 11 to control the cursor 133 corresponding to the host device 13 through the central control device 31. Accordingly, the portable navigation device 11 can be used to control the controlled device 15 or perform data transmission through the host device 13 and the central control device 31.

Data transmission can be conducted when the host device 13 transmits the data to the portable navigation device 11 through the central control device 31 and the portable navigation device 11 transmits the data to the controlled device 15 corresponding to the interactive interface 151′. Data transmission can also be conducted when the host device 13 transmits the data to the controlled device 15 through the central control device 31.

With the central control device 31, the interactive system 30 for controlling multiple remote devices according to the present invention may be used more diversely. For example, the central control device 31 may be powered or charged by an external power supply through the socket 313 and receive the portable navigation device 11 when the portable navigation device 11 is not being used. Moreover, for example, the central control device 31 can be wiredly linked to the host device 13 such that the portable navigation device 11 can be powered or charged by the host device 13 through the central control device 31. If the portable navigation device 11 is wirelessly linked to the central control device 31 and the central control device 31 is wiredly linked to the host device 13, a wireless transmission module (not shown) of the central control device 31 can be designed to match a wireless transmission module (not shown) of the portable navigation device 11 such that the portable navigation device 11 of the operate interactive system 30 provides excellent wireless communication quality unlimited by the wireless transmission module (not shown) of the host device 13.

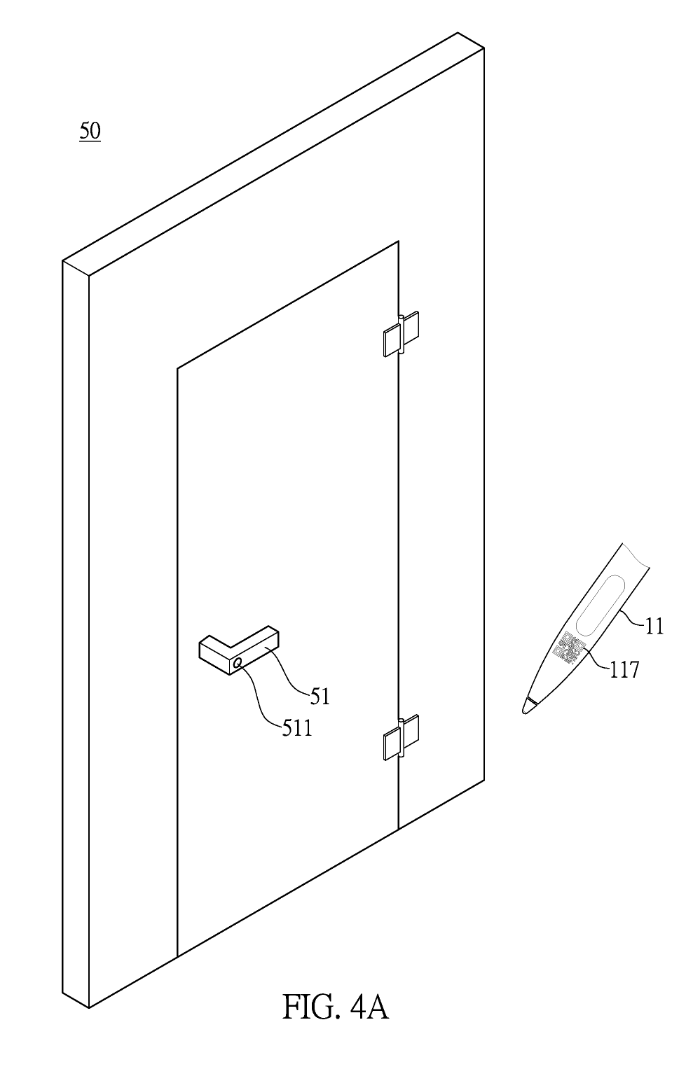

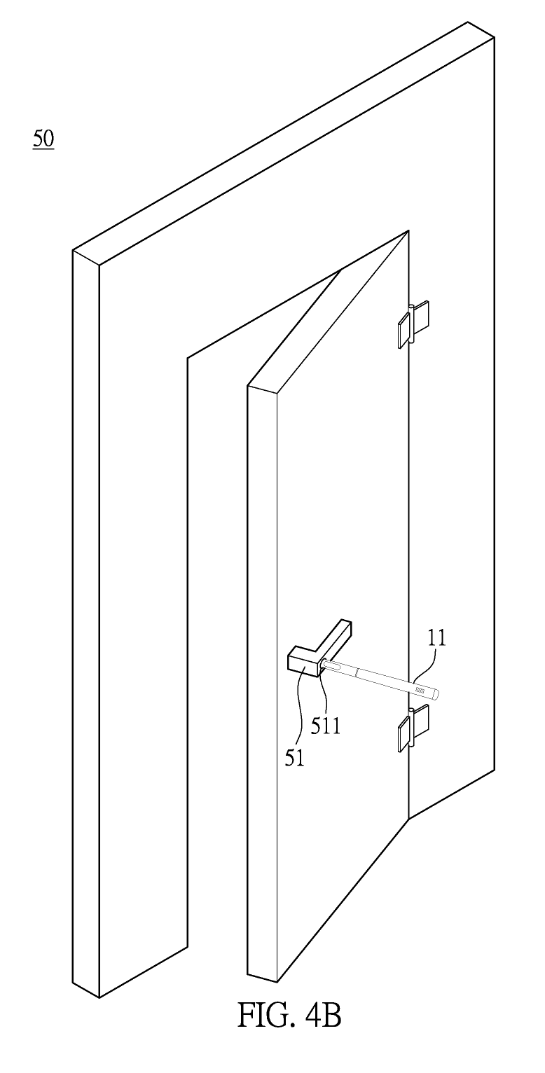

Referring to FIG. 4A and FIG. 4B, FIG. 4A and FIG. 4B are schematic diagrams of an interactive system for controlling multiple remote devices according to another embodiment of the present invention. In FIG. 4A and FIG. 4B, the interactive system 50 includes a portable navigation device 11 and a key hole 51. The portable navigation device 11 includes a pattern 117. The key hole 51 includes an identification unit 511. The portable navigation device 11 is a pen mouse, to which the present invention is not limited.

As shown in FIG. 4A, the pattern 117 on the portable navigation device 11 includes any drawings, lines or barcodes, to which the present invention is not limited. The key hole 51 is installed on any doors, security boxes or vehicles to be locked/unlocked or activated, to which the present invention is not limited. The identification unit 511 of the key hole 51 is an optical identifier, to which the present invention is not limited.

As shown in FIG. 4B, the portable navigation device 11 can be partially plugged into the key hole 51 such that the identification unit 511 of the key hole 51 identifies the pattern 117 on the portable navigation device 11. After being identified by the identification unit 511, if the pattern 117 on the portable navigation device 11 conforms to reference data (not shown) pre-stored in the key hole 51, the key hole 51 can be locked/unlocked or activated. With the pattern 117 on the portable navigation device 11 and the key hole 51, the portable navigation device 11 according to the present invention provides such locking/unlocking function and can be used more diversely.

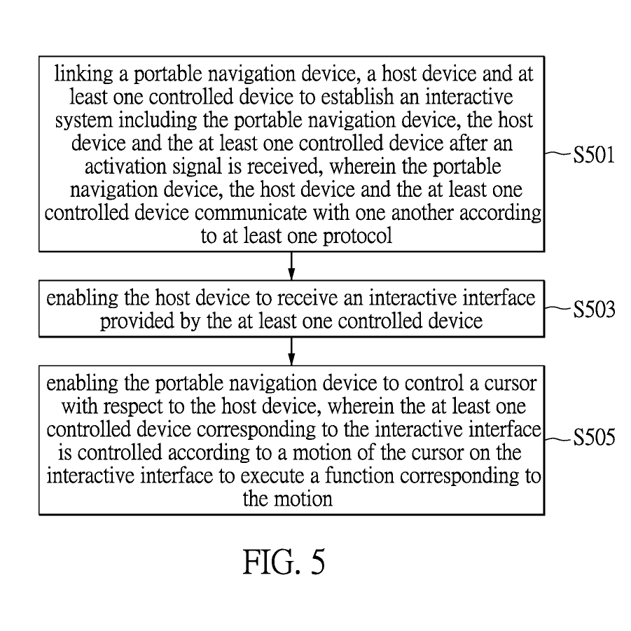

FIG. 5 is a flowchart of an interactive method for controlling multiple remote devices according to one embodiment of the present invention. Referring to FIG. 5 and FIG. 1, the interactive method for controlling multiple remote devices according to the present invention uses at least one controlled device 15. In the present embodiment, the at least one controlled device 15 is exemplified by a controlled device 15. In FIG. 5, Step S501 is performed such that a portable navigation device 11, a host device 13 and at least one controlled device 15 are linked after an activation signal is received to establish an interactive system 10 including the portable navigation device 11, the host device 13 and the at least one controlled device 15. The portable navigation device 11, the host device 13 and the controlled device 15 communicate with one another according to at least one protocol. Then, in Step S503, the host device 13 receives an interactive interface 151′ corresponding to an interactive interface 151 provided by the controlled device 15. In Step S505, the portable navigation device 11 controls a cursor 133 with respect to the host device 13 and controls the controlled device 15 corresponding to the interactive interface 151′ according to a motion of the cursor 133 on the interactive interface 151′ to execute a function corresponding to the motion. Accordingly, the portable navigation device 11 can be used to control the controlled device 15 or perform data transmission through the host device 13.

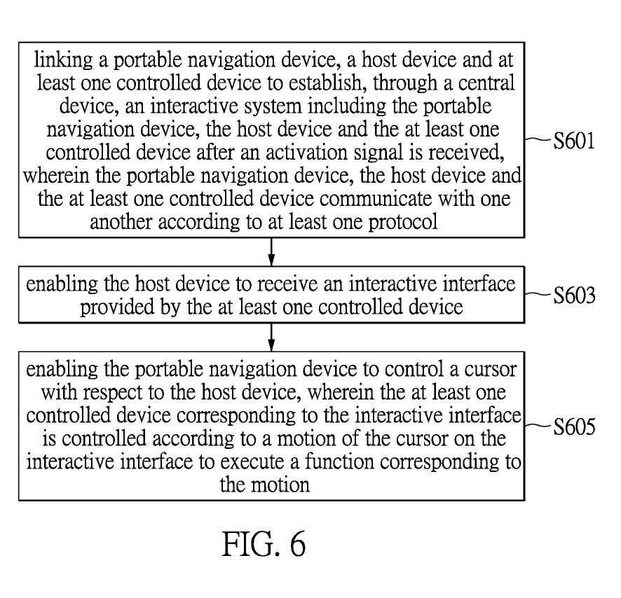

FIG. 6 is a flowchart of an interactive method for controlling multiple remote devices according to another embodiment of the present invention. Referring to FIG. 6 and FIG. 3, the interactive method for controlling multiple remote devices according to the present invention uses at least one controlled device 15. In the present embodiment, the at least one controlled device 15 is exemplified by a controlled device 15. In FIG. 6, Step S601 is performed such that a portable navigation device 11, a host device 13 and at least one controlled device 15 are linked after an activation signal is received to established, through a central device 31, an interactive system 10 including the portable navigation device 11, the host device 13 and the at least one controlled device 15. The portable navigation device 11, the host device 13 and the controlled device 15 communicate with one another according to at least one protocol. Then, in Step S603, the host device 13 receives an interactive interface 151′ corresponding to an interactive interface 151 provided by the controlled device 15. In Step S605, the portable navigation device 11 controls a cursor 133 with respect to the host device 13 through the central device 31 and controls the controlled device 15 corresponding to the interactive interface 151′ according to a motion of the cursor 133 on the interactive interface 151′ to execute a function corresponding to the motion. Accordingly, the portable navigation device 11 can be used to control the controlled device 15 or perform data transmission through the host device 13.

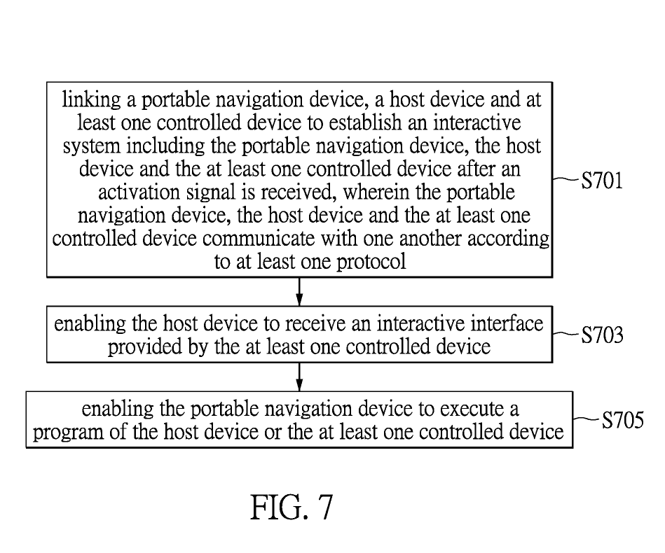

FIG. 7 is a flowchart of an interactive method for controlling multiple remote devices according to still another embodiment of the present invention. Referring to FIG. 7 and FIG. 1, the interactive method for controlling multiple remote devices according to the present invention uses at least one controlled device 15. In the present embodiment, the at least one controlled device 15 is exemplified by one controlled device 15. In FIG. 7, Step S701 is performed such that a portable navigation device 11, a host device 13 and at least one controlled device 15 communicate with one another according to at least one protocol after an activation signal is received to establish an interactive system 10 including the portable navigation device 11, the host device 13 and the at least one controlled device 15. Then, in Step S703, the host device 13 receives an interactive interface 151′ corresponding to an interactive interface 151 provided by the controlled device 15. In Step S705, the portable navigation device 11 is operated to execute a program of the host device 13 or the controlled device 15. Accordingly, the portable navigation device 11 can be used to execute a program of the host device 13 or the controlled device 15.

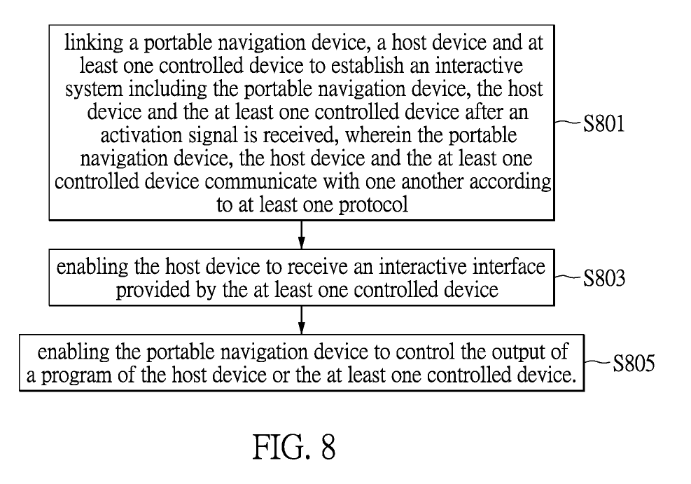

FIG. 8 is a flowchart of an interactive method for controlling multiple remote devices according to still another embodiment of the present invention. Referring to FIG. 8 and FIG. 1, the interactive method for controlling multiple remote devices according to the present invention uses at least one controlled device 15. In the present embodiment, the at least one controlled device 15 is exemplified by a controlled device 15. In FIG. 8, Step S801 is performed such that a portable navigation device 11, a host device 13 and at least one controlled device 15 communicate with one another according to at least one protocol after an activation signal is received to establish an interactive system 10 including the portable navigation device 11, the host device 13 and the at least one controlled device 15. Then, in Step S803, the host device 13 receives an interactive interface 151′ corresponding to an interactive interface 151 provided by the controlled device 15. In Step S805, the portable navigation device 11 is operated to control the output of a program of the host device 13 or the controlled device 15. Accordingly, the portable navigation device 11 can be used to control the output of a program of the host device 13 or the controlled device 15.

In summary, in view of the above teachings, an interactive system and a method thereof for controlling multiple remote devices according to the present invention use a portable navigation device, a host device and at least one controlled device communicating with one another according to at least one protocol to establish the interactive system including the portable navigation device, the host device and the at least one controlled device such that the portable navigation device can be used to control the controlled device or perform data transmission through the host device.

The above-mentioned descriptions represent merely the exemplary embodiment of the present invention, without any intention to limit the scope of the present invention thereto. Various equivalent changes, alterations or modifications based on the claims of present invention are all consequently viewed as being embraced by the scope of the present invention.

What is claimed is:

1. An interactive system, comprising:
a portable navigation device;
a host device; and
at least one controlled device;
wherein said portable navigation device, said host device and said at least one controlled device communicate with one another according to at least one protocol to establish said interactive system comprising said portable navigation device, said host device and said at least one controlled device;
wherein said host device receives an interactive interface provided by said at least one controlled device;
wherein said portable navigation device controls a cursor with respect to said host device, executes a program of said host device or said at least one controlled device and controls the output of an application of said host device or said at least one controlled device;
wherein said at least one controlled device corresponding to said interactive interface is controlled according to a motion of said cursor on said interactive interface to execute a function corresponding to said motion.

2. The interactive system of claim 1, wherein said function is data transmission enabled by performing said motion such that said data transmission is conducted between said host device and said at least one controlled device corresponding to said interactive interface directly or through said portable navigation device based on said motion.

3. The interactive system of claim 1, wherein said portable navigation device further comprises a microphone receiving an audio signal provided by the user, said portable navigation device controlling said host device and said at least one controlled device according to said audio signal to execute a voice control function corresponding to said audio signal.

4. The interactive system of claim 3, wherein said interactive system is established after receiving an activation signal, said activation signal being a trajectory signal corresponding to a movement of said portable navigation device, said audio signal or an input signal when at least one button of said portable navigation device is being pressed.

5. The interactive system of claim 1, wherein said at least one protocol is Bluetooth, Wi-Fi, near field communication (NFC), ZigBee or radio frequency identification (RFID).

6. The interactive system of claim 1, further comprising a central control device, said interactive system being established comprising said portable navigation device, said host device and said at least one controlled device using said central control device.

7. The interactive system of claim 1, further comprising a key hole, said portable navigation device further comprising a pattern disposed thereon to be identified by said key hole to determine if said key hole is to be locked or unlocked.

8. An interactive method for controlling multiple remote devices, being executed by a portable navigation device, said interactive method comprising:
linking said portable navigation device, a host device and at least one controlled device to establish an interactive system comprising said portable navigation device, said host device and said at least one controlled device, wherein said portable navigation device, said host device and said at least one controlled device communicate with one another according to at least one protocol;
enabling said host device to receive an interactive interface provided by said at least one controlled device; and
enabling said portable navigation device to control a cursor with respect to said host device, execute a program of said host device or said at least one controlled device and control the output of an application of said host device or said at least one controlled device;
wherein said at least one controlled device corresponding to said interactive interface is controlled according to a motion of said cursor on said interactive interface to execute a function corresponding to said motion.

9. The interactive method of claim 8, wherein said function is data transmission enabled by performing said motion such that said data transmission is conducted between said host device and said at least one controlled device corresponding to said interactive interface directly or through said portable navigation device based on said motion.

10. The interactive method of claim 8, wherein said portable navigation device further comprises a microphone receiving an audio signal provided by the user, said portable navigation device controlling said host device and said at least one controlled device according to said audio signal to execute a voice control function corresponding to said audio signal.

11. The interactive method of claim 10, wherein said interactive system is established after receiving an activation signal, said activation signal being a trajectory signal corresponding to a movement of said portable navigation device, said audio signal or an input signal when at least one button of said portable navigation device is being pressed.

12. The interactive method of claim 8, wherein said at least one protocol is Bluetooth, Wi-Fi, near field communication (NFC), ZigBee or radio frequency identification (RFID).

13. The interactive method of claim 8, wherein said interactive system is established, through a central device, to comprise said portable navigation device, said host device and said at least one controlled device using a central control device.

14. The interactive method of claim 8, wherein said portable navigation device further comprises a pattern disposed thereon to be identified by a key hole to determine said key hole to be locked or unlocked.
